(19) United States
(12) Patent Application Publication
(10) Pub. No.: US 2021/0070445 A1
(43) Pub. Date: Mar. 11, 2021

(54) Console Mounted Pilot Tray Assembly

(71) Applicant: Trever Andrew Rossini, Eden Prairie, MN (US)

(72) Inventor: Trever Andrew Rossini, Eden Prairie, MN (US)

(21) Appl. No.: 16/566,561

(22) Filed: Sep. 10, 2019

(51) Int. Cl. B64D 11/00; B64D 43/00

(52) U.S. Cl. CPC B64D 11/00; B64D 43/00

(57) ABSTRACT

A console mounted pilot tray assembly includes an aircraft cockpit having a console. A seat is mounted in the aircraft and faces the console. A side stick is mounted laterally to the console and a leg receiving space is positioned under the console. A mount is positioned under and is mounted to the console. The mount includes a guide rail. A panel has a top side, a bottom side, a front edge, a rear edge, a first side edge and a second side edge. A slide attached to the panel and is moveably mounted to the guide rail. The panel is moved along the guide rail and under the console to define a stored position. The panel is moved to a deployed position. The deployed position is defined as the panel extending outwardly away from the guide rail and the console.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to a stowable tray device and more particularly pertains to a new stowable tray device particularly well suited for usage by an aircraft pilot. The device of disclosure provides a tray for the pilot in such a manner that its positioning does not interfere with flight controls. The tray, in turn, provides a location for the pilot to place food or other articles such that these items need not be held while flying which can interfere with the pilot's duties as well as be cumbersome within the small confines of a cockpit. While in the stowed position, the tray also will not interfere with the usable leg space of the cockpit.

### (2) Description of Related Art Including Information Disclosed Under 37 CFR 1.97 and 1.98

The prior art relates to stowable tray devices which provide a location for the placement of food, electronics, paperwork or other like articles. Such devices are typically stowable when not in use, however these devices are not suitable for usage in a cockpit where space is more constrained and a tray might otherwise interfere with

### BRIEF SUMMARY OF THE INVENTION

An embodiment of the disclosure meets the needs presented above by generally comprising an aircraft cockpit having a console. A seat is mounted in the aircraft and faces the console. A side stick is mounted laterally to the console and a leg receiving space is positioned under the console. A mount is positioned under and is mounted to the console. The mount includes a guide rail. A panel has a top side, a bottom side, a front edge, a rear edge, a first side edge and a second side edge. A slide attached to the panel and is moveably mounted to the guide rail. The panel is moved along the guide rail and under the console to define a stored position. The panel is moved to a deployed position. The deployed position is defined as the panel extending outwardly away from the guide rail and the console.

In another embodiment, the mount is positioned under is mounted to the console. The mount includes a rear wall, a top wall and a pair of side walls. Each of the side walls comprises a guide rail. A panel has a top side, a bottom side, a front edge, a rear edge, a first side edge and a second side edge. A pair of slides is provided. Each of the first and second side edges has one of the slides mounted thereto. Each of the slides is moveably mounted to one of the guide rails. The slides are positioned adjacent to the rear edge. The panel is moved along the guide rails to the rear wall to define a stored position. The panel is movable to a deployed position defined as the panel extending outwardly away from the guide rails. The guide rails lie in a first plane while the panel lies in a second plane when the panel is in the deployed position. The second plane is horizontally orientated and the first plane is inclined at an angle between 25° and 30°.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a side isometric view of a console mounted pilot tray assembly according to an embodiment of the disclosure.

FIG. 2 is a side isometric view of an embodiment of the disclosure.

FIG. 3 is a bottom view of an embodiment of the disclosure.

FIG. 4 is a side view of an embodiment of the disclosure.

FIG. 5 is a side view of an embodiment of the disclosure.

FIG. 6 is a top isometric view of an embodiment of the disclosure.

### DETAILED DESCRIPTION OF THE INVENTION

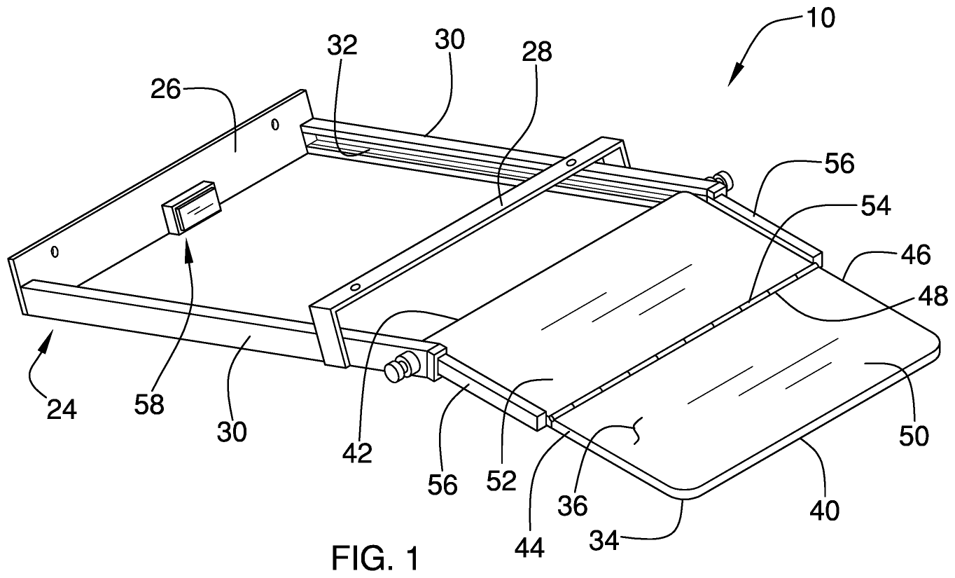

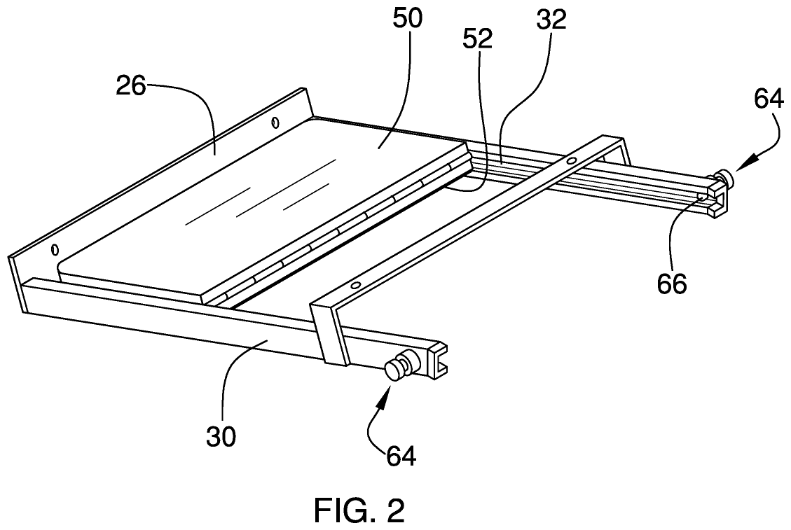

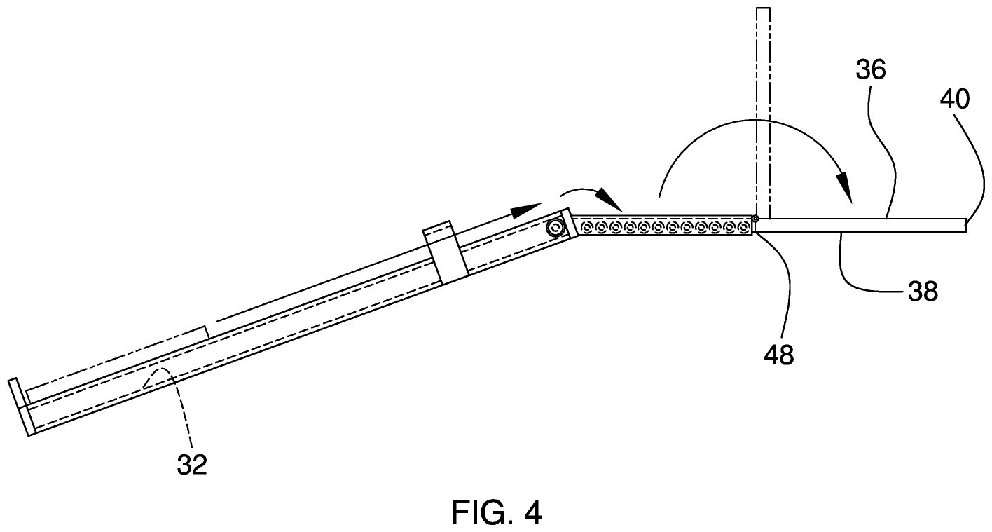

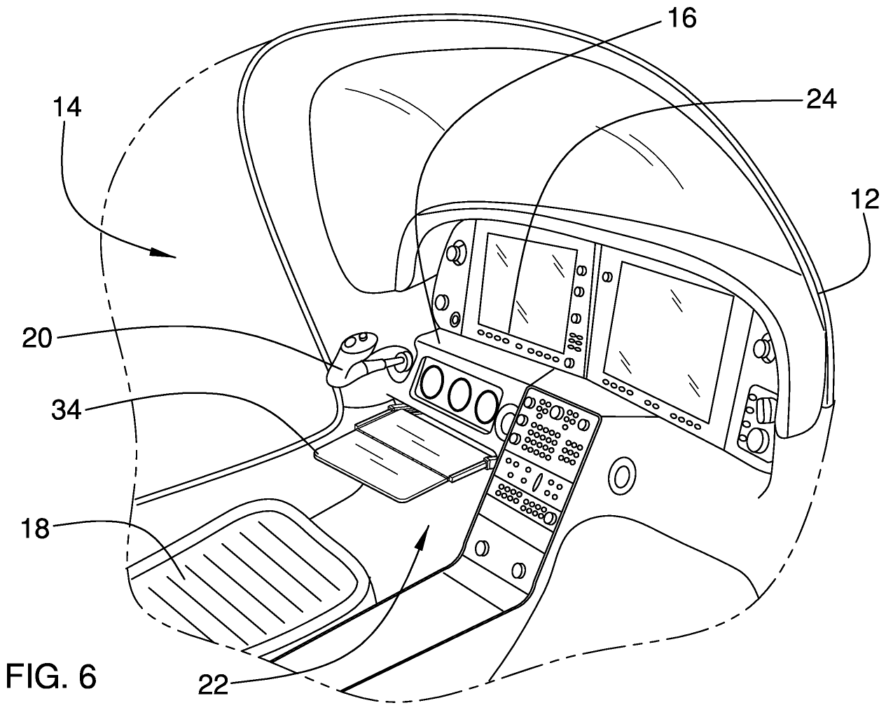

With reference now to the drawings, and in particular to FIGS. 1 through 6 thereof, a new stowable tray device embodying the principles and concepts of an embodiment of the disclosure and generally designated by the reference numeral 10 will be described.

As best illustrated in FIGS. 1 through 6, the console mounted pilot tray assembly 10 generally comprises a conventional aircraft 12 cockpit 14 that has a console 16. A seat 18 is mounted in the aircraft 12 and faces the console 14. A side stick 20 is mounted laterally to the console 16 and seat 18 and a leg receiving space 22 is positioned under the console 16. The side stick 20 is used as the control stick for the aircraft 12. The console 16 includes a front face 24 having the instrumentation thereon.

A mount 24 is positioned under and is mounted to the console 16. The mount 24 may include a rear wall 26, a top wall 28 and a pair of side walls 30. While a frame type mount may be utilized as shown in the Figures, the mount 24 may alternatively comprise a housing. In one embodiment, each of the side walls 30 includes a guide rail 32. Alternate embodiments may include a housing attached to the console 16 with a guide rail 32 suspended downwardly through the bottom wall of the housing. As can be understood from the Figures, fasteners may be extended through the rear wall 26 and the top wall 28 to a bottom side of the console 16 above the leg receiving space 22.

A panel 34 is provided which has a top side 36, a bottom side 38, a front edge 40, a rear edge 42, a first side edge 44 and a second side edge 46. The panel 34 has a break 48 therein extending between through the first 44 and second 46 side edges to define a first section 50 and a second section 52 of the panel 34. A hinge 54 pivotally couples the first section 50 to the second section 52. In one embodiment, the top side 36 of the second section 52 is abuttable against the top side 36 of the first section 50 to define a folded condition and the top sides 36 of the first 50 and second 52 sections are co-planar to define an unfolded condition. The panel 34 has a width from the first side edge 44 to the second side edge 46 being greater than 8.0 inches and a depth from the front edge 40 to the rear edge 42 greater than 7.0 inches. The corners of the panel 34 where the front edge 40 intersects the first 44 and second 42 side edges are rounded.

In one embodiment, a pair of slides 56 is provided and each of the first 44 and second 46 side edges has one of the slides 56 mounted thereto. Each of the slides 56 is moveably mounted in a linear motion to one of the guide rails 32. The slides 56 are positioned adjacent to the rear edge 42 and more particularly are positioned on the second section 52. If the guide rail, as mentioned above, extends through the bottom wall of a housing, a slide 56 may be attached to a bottom side 38 of the panel 34.

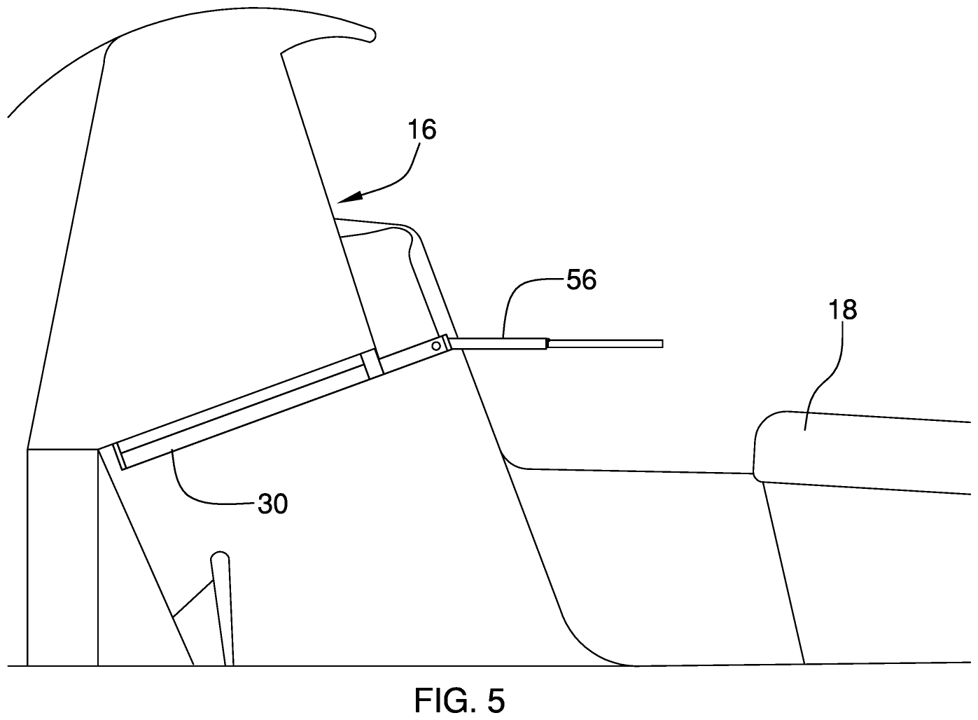

The panel 34 is moved along the guide rails 32 to the rear wall 26 to define a stored position. The panel 34 is movable to a deployed position defined as the panel 34 extending outwardly away from the guide rails 32 as shown in FIG. 1. The panel 34 will typically move about 18.0 inches from the deployed position to the stored position. The guide rails 32 lie in a first plane while the panel 34 lies in a second plane when the panel 34 is in the deployed position. The second plane is horizontally orientated while the first plane is inclined at an angle between 20° and 35° and more particularly between 25° and 30° as shown in FIG. 5. As can be seen in FIG. 1, the guide rails 32 and slides 56 form a generally conventional track system wherein the slides 56 extend outwardly from the guide rails 32 where thereafter the slides 56 can be pivoted relative to the guide rails 32. The panel 34 is movable to the unfolded condition when the panel 34 is in the deployed position and to the folded condition before being placed in the stored position.

A retaining member 58 is mounted on the mount 24. The retaining member 58 releasably retains the panel 34 in the stored position. While this may include multiple conventional structures, one may include a magnet 60 mounted on the rear wall 26 which magnetically engages the panel 34 when the panel 34 is in the stored position. The magnet 60 is biased outwardly by a spring 62. When the panel 34 is engaged with the retaining member 58, the panel 34 may be urged inwardly toward the rear wall 26 and released to cause the panel 34 to be pushed outwardly by the spring 62 to result in disengagement from the magnet 60.

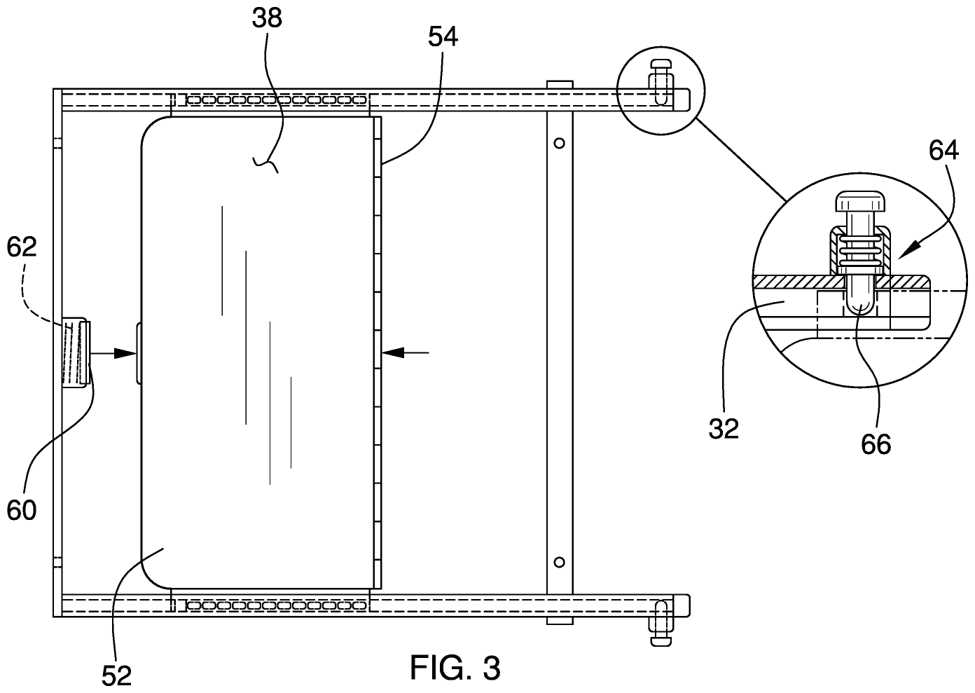

A locking member 64 is mounted on the mount 24. The locking member 64 releasably engages the panel 36 when the panel 36 is in the deployed position to releasably retain the panel 36 in the deployed position. In one embodiment, the locking member 64 is a pin 66, as shown in FIG. 3 which engages the slide 56 to prevent its movement relative to the guide rail 32.

In use, the panel 34 of the assembly 10 is used a tray for a pilot of the aircraft 12. The panel 34 is retained under the console 16 when not in use. However, even when extended, the panel 34 will not interfere with the usage of the side stick 20 or other instrumentation. The panel 34 allows the pilot to place food, drinks or other articles in front of the console 16 so that the pilot need not hold onto these items while flying. The assembly 10 does not obstruct viewing console instrumentation while ensuring that the hand's of the pilot are free to utilize the aircraft controls. When stowed, the panel does not interfere with usage of the instrumentation or the available leg space in front of the seat 18.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A cockpit tray table system comprising:
an aircraft cockpit having a console, a seat being mounted in said aircraft and facing said console, a side stick being mounted laterally to said console, a leg receiving space being positioned under said console;
a mount being positioned under and being mounted to said console, said mount including a guide rail;
a panel having a top side, a bottom side, a front edge, a rear edge, a first side edge and a second side edge;
a slide attached to said panel, said slide being moveably mounted to said guide rail;
said panel being moved along said guide rail and under said console to define a stored position, said panel being moved to a deployed position, said deployed position being defined as said panel extending outwardly away from said guide rail and extended outwardly from said console.

2. The cockpit tray table system according to claim 1, wherein said panel has a break therein extending between through said first and second side edges to define a first section and a second section of said panel, a hinge pivotally coupling said first section to said second section, said top side of said second section being abuttable against said top side of said first section to define a folded condition, said top sides of said first and second sections being co-planar to define an unfolded condition, said panel being placed in said folded condition before being placed in said stored position.

3. The cockpit tray table system according to claim 1, wherein said panel lying in a first plane when said panel is in said stored position, said panel lying in a second plane when said panel is in said deployed position, said second plane being horizontally orientated, said first plane being inclined at an angle between 25° and 30°.

4. The cockpit tray table system according to claim 3, wherein said panel has a break therein extending between through said first and second side edges to define a first section and a second section of said panel, a hinge pivotally coupling said first section to said second section, said top side of said second section being abuttable against said top side of said first section to define a folded condition, said top sides of said first and second sections being co-planar to define an unfolded condition, said panel being movable to said unfolded condition when said panel is in said deployed position, said panel being moved to said folded condition before being placed in said stored position.

5. The cockpit tray table system according to claim 4, further including a retaining member being mounted on said mount, said retaining member releasably retaining said panel in said stored position.

6. The cockpit tray table system according to claim 5, further including a locking member being mounted on said mount, said locking member releasably engaging said panel when said panel is in said deployed position to releasably retain said panel in said deployed position.

7. The cockpit tray table system according to claim 1, further including a retaining member being mounted on said mount, said retaining member releasably retaining said panel in said stored position.

8. The cockpit tray table system according to claim 7, further including a locking member being mounted on said mount, said locking member releasably engaging said panel when said panel is in said deployed position to releasably retain said panel in said deployed position.

9. A cockpit tray table system comprising:
an aircraft cockpit having a console, a seat being mounted in said aircraft and facing said console, a side stick being mounted laterally to said console, a leg receiving space being positioned under said console;
a mount being positioned under and being mounted to said console, said mount including a rear wall, a top wall and a pair of side walls, each of said side walls comprising a guide rail;
a panel having a top side, a bottom side, a front edge, a rear edge, a first side edge and a second side edge;
a pair of slides, each of said first and second side edges having one of said slides mounted thereto, each of said slides being moveably mounted to one of said guide rails, said slides being positioned adjacent to said rear edge;
said panel being moved along said guide rails to said rear wall to define a stored position, said panel being moved to a deployed position, said deployed position being defined as said panel extending outwardly away from said guide rails, said guide rails lying in a first plane, said panel lying in a second plane when said panel is in said deployed position, said second plane being horizontally orientated, said first plane being inclined at an angle between 25° and 30°.

10. The cockpit tray table system according to claim 9, wherein said panel has a break therein extending between through said first and second side edges to define a first section and a second section of said panel, a hinge pivotally coupling said first section to said second section, said top side of said second section being abuttable against said top side of said first section to define a folded condition, said top sides of said first and second sections being co-planar to define an unfolded condition, said slides being positioned on said second section.

11. The cockpit tray table system according to claim 10, wherein said panel is movable to said unfolded condition when said panel is in said deployed position, said panel being moved to said folded condition before being placed in said stored position.

12. The cockpit tray table system according to claim 11, further including a retaining member being mounted on said mount, said retaining member releasably retaining said panel in said stored position.

13. The cockpit tray table system according to claim 12, further including a locking member being mounted on said mount, said locking member releasably engaging said panel when said panel is in said deployed position to releasably retain said panel in said deployed position.

14. The cockpit tray table system according to claim 9, further including a retaining member being mounted on said mount, said retaining member releasably retaining said panel in said stored position.

15. The cockpit tray table system according to claim 9, further including a locking member being mounted on said mount, said locking member releasably engaging said panel when said panel is in said deployed position to releasably retain said panel in said deployed position.
